(19) United States
(12) Patent Application Publication
(10) Pub. No.: US 2004/0228374 A1
(43) Pub. Date: Nov. 18, 2004

(54) Laser control device

(75) Inventor: Katsumi Inukai, Iwakura-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 10/843,479

(22) Filed: May 12, 2004

(30) Foreign Application Priority Data
May 13, 2003 (JP) 2003-134256

(51) Int. Cl. H01S 3/13; B41J 2/385; G03G 13/04; F21K 2/00

(52) U.S. Cl. 372/31; 347/130

(57) ABSTRACT

To achieve strong-illumination and weak-illumination of a laser beam onto a photo-sensitive drum, a laser control device controls an LD drive current switching circuit to switch between drive currents generated by an LD-bright-lighting current drive control circuit and drive currents generated by an LD-dim-lighting current drive control circuit, and applies the selected drive currents to a semiconductor laser element. The laser beam from the semiconductor laser element is detected by a photodiode, and the drive current is adjusted by feedback control based on the detected optical intensity. Since a detection signal from the photodiode is amplified not only when the laser beam is illuminating strongly but also when the laser beam is illuminating weakly, even tiny variations in the optical intensity during weak illumination can be detected clearly and can be reflected in feedback control. Thus, the laser control device feeds back the optical intensity of the laser beam to ensure that the optical intensity of the laser beam is kept constant.

### BACKGROUND OF THE INVENTION

1. Field of the Invention

The present invention relates to a laser control device for controlling a semiconductor laser element to emit a laser beam.

2. Description of Related Art

An image forming device, such as a laser printer, employs, as a light source, a laser control device provided with a semiconductor laser element (a laser diode (LD)). A laser beam emitted from the semiconductor laser element is irradiated onto an electrically-charged photosensitive drum. An invisible image (latent image) is formed on the photosensitive drum by potential differences created between portions that have been irradiated by the laser beam (light portions) and portions that have not been so irradiated (dark portions). This latent image is then developed by a developer such as toner, and an image is formed on a recording medium when the developed image is transferred to the recording medium.

When it is intended to form light portions on the photosensitive drum, the semiconductor laser element is applied with a current whose amount is sufficiently greater than a threshold current so that the semiconductor laser element lights brightly. When the semiconductor laser element is applied with a current whose amount is slightly greater than the threshold current, the semiconductor laser element lights dimly. Accordingly, when it is intended to form dark portions, the semiconductor laser element is applied with a current, whose amount is slightly greater than the threshold current but is smaller than the amount of the current for forming the light portions, so that the semiconductor laser element lights dimly. The intensity of the laser beam emitted from the semiconductor laser element is sufficiently weaker than that emitted from the semiconductor laser element to form the light portions. Accordingly, the dark portions are formed on the photosensitive drum. It is possible to switch the semiconductor laser element rapidly between the bright-lighting state and the dim-lighting state.

The semiconductor laser element, however, has a disadvantage in that the threshold current and the current/light conversion ratio vary widely with variations in temperature.

If a current whose amount causes dim lighting is applied to the semiconductor laser element while it is intended to form dark portions on the photosensitive drum and a current whose amount causes bright lighting is applied to the semiconductor laser element while it is intended to form light portions, temperature variations of the semiconductor laser element will occur and the optical intensities of the laser beam will no longer be stable.

U.S. Pat. No. 5,274,653 discloses that during a period of time after a laser beam modulation operation is completed and before the next laser beam modulation operation is started, the magnitude of the current flowing during bright-lighting is adjusted in such a manner that the optical intensity of the brightly-lighting laser beam approaches a reference value and the magnitude of the current flowing during dim-lighting is adjusted in such a manner that the optical intensity of the dimly-lighting laser beam approaches another reference value.

### SUMMARY OF THE INVENTION

It is an objective of the present invention to provide an improved laser control device that can accurately keep constant the optical intensity of a laser beam emitted from a laser source when the laser source is in the bright-lighting condition and that can accurately keep constant the optical intensity of the laser beam when the laser source is in the dim-lighting condition.

In order to attain the above and other objects, the present invention provides a laser control device including; a laser beam emission portion; a laser beam drive portion; an optical intensity detection portion; an amplification portion; an amplification ratio setting portion; and a control portion. The laser beam emission portion emits a laser beam. The laser beam drive portion receives a modulation signal from outside and drives the laser beam emission portion to selectively generate a laser beam of a first optical intensity and a second optical intensity that is weaker than the first optical intensity. The optical intensity detection portion detects the optical intensity of the laser beam emitted from the laser beam emission portion. The amplification portion amplifies, at an amplification ratio, a detection signal outputted from the optical intensity detection portion. The amplification ratio setting portion sets the amplification ratio in such a manner that the amplification ratio with respect to the detection signal for the second optical intensity is greater than the amplification ratio with respect to the detection signal for the first optical intensity. The control portion outputs a control signal to the laser beam drive portion to control the laser beam drive portion to drive the laser beam emission portion to selectively emit the laser beam of the first optical intensity and the second optical intensity. The control portion includes an optical intensity adjustment portion. The optical intensity adjustment portion adjusts the first optical intensity and the second optical intensity to keep constant. The optical intensity adjustment portion executes the adjustment operation based on the amplified detection signal.

According to another aspect, the present invention provides a laser control device including: a laser diode; a laser drive portion; a photodiode; an amplification portion, an amplification ratio setting portion; and a control portion. The laser diode emits a laser beam. The laser drive portion drives the laser diode to selectively generate a laser beam of a first optical intensity and a second optical intensity that is weaker than the first optical intensity. The photodiode detects the optical intensity of the laser beam. The amplification portion amplifies, at an amplification ratio, a detection signal outputted from the photodiode. The amplification ratio setting portion sets the amplification ratio in such a manner that the amplification ratio with respect to the detection signal for the second optical intensity is greater than the amplification ratio with respect to the detection signal for the first optical intensity. The control portion controls the laser drive portion to drive the laser diode to selectively emit the laser beam of the first optical intensity and the second optical intensity. The control portion includes an optical intensity adjustment portion. The optical intensity adjustment portion adjusts the first optical intensity to have a predetermined first value and that adjusts the second optical intensity to have a predetermined second value. The optical intensity adjustment portion executes the adjustment operation based on the amplified detection signal.

### BRIEF DESCRIPTION OF THE DRAWINGS

The above and other objects, features and advantages of the invention will become more apparent from reading the following description of the preferred embodiment taken in connection with the accompanying drawings in which:

FIG. 1 is a schematic view showing the overall configuration of a laser printer according to an embodiment of the present invention;

FIG. 2 is a block diagram showing the configuration of a laser control device mounted in the laser printer of FIG. 1; and

FIG. 3 is a flowchart of a laser control program executed by the laser control device of FIG. 2.

### DETAILED DESCRIPTION OF THE PREFERRED EMBODIMENT

A laser control device according to a preferred embodiment of the present invention will be described while referring to the accompanying drawings wherein like parts and components are designated by the same reference numerals to avoid duplicating description.

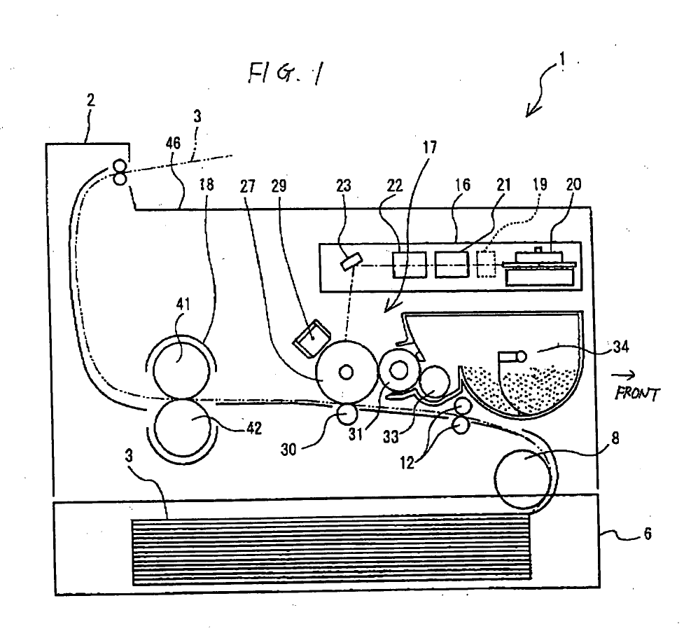

With reference to FIG. 1, a laser printer 1 provided with a laser control portion 100 according to the present embodiment will be described. The right side of FIG. 1 is the front side of the laser printer 1.

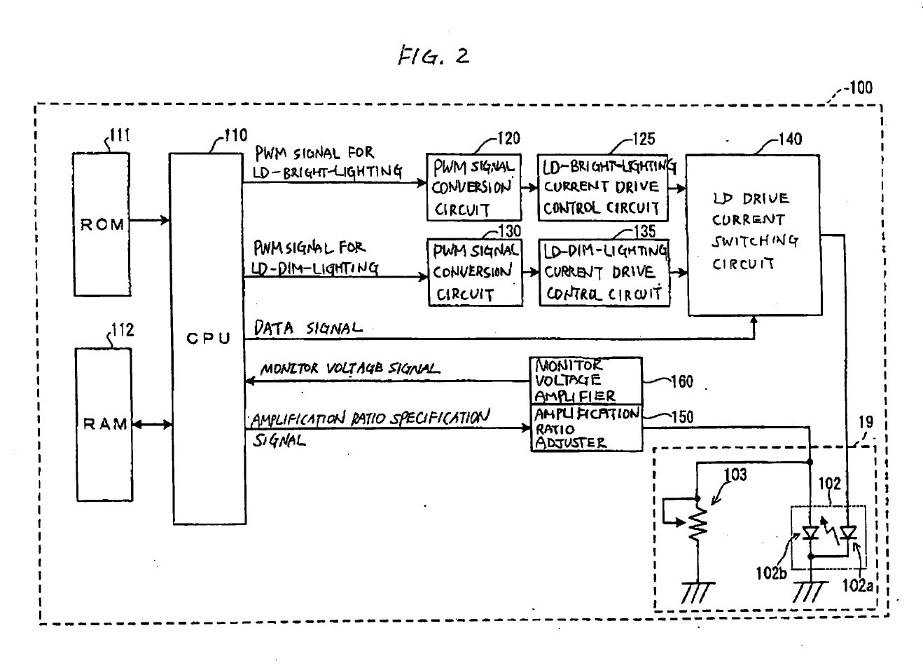

The laser control portion 100 serves as a light source for the laser printer 1. The laser control portion 100 (FIG. 2) is mounted on a scanner unit 16. The laser control portion 100 is provided with a laser beam emitting section 19. A semiconductor laser element 102a (laser diode LD)) is provided in the laser beam emitting section 19. The laser control portion 100 controls driving of the semiconductor laser element 102a so that the semiconductor laser element 102a emits a laser beam.

The laser printer 1 has a case 2 of substantially a rectangular parallelpiped shape. A paper supply cassette 6 is mounted removably into a base portion of the case 2. Papers 3 are held in a stack in the paper supply cassette 6, and the uppermost paper 3 is in contact with a paper supply roller 8, which is provided above the paper supply cassette 6 at the front surface side of the case 2. As the paper supply roller 8 rotates, the uppermost paper 3 is transported along a U-shaped transport path (indicated by two-dotted chain line in FIG. 1), and is fed to resist rollers 12.

In substantially the center of the case 2, there are provided the scanner unit 16, a process portion 17, and a fixing device 18, which are for forming images on the sheets of paper 3.

The scanner unit 16 is disposed directly below a sheet discharge tray 46 in the main body case 2, and includes the laser beam emitting section 19, a polygonal mirror 20, an f θ lens 21, a cylindrical lens 22, and a reflecting mirror 23. The laser beam emitting section 19 irradiates a laser beam. The polygonal mirror 20 rotates to scan the laser beam from the laser beam emitting section 19 in a main scanning direction across the surface of a photosensitive drum 27. The fθ lens 21 is for stabilizing scanning speed of the laser beam reflected from the polygon mirror 20. The cylindrical lens 22 is for compensating for the cross-scan error (optical face tangle error) of the scanner laser beam. The reflecting mirror 23 is for reflecting the laser beam that has passed through the cylindrical lens 22 and for imaging the laser beam onto the photosensitive drum 27. With this configuration, the laser beam is irradiated from the laser beam emitting section 19 based upon print data and passes through or is reflected by the polygonal mirror 20, the fθ lens 21, the cylindrical lens 22, and the reflecting mirror 23 in this order as indicated by an alternate long and dash lines L in FIG. 1 to expose and scan the surface of a photosensitive drum 27 in the process portion 17. The laser control portion 100 is provided on a side surface of a casing of the scanner unit 16. The laser control portion 100 controls the semiconductor laser element 102a (FIG. 2) to emit the laser beam.

The process portion 17 includes the photosensitive drum 27, a Scorotron charger 29, a developing roller 31, and a transfer roller 30. The photosensitive drum 27 is located below the scanner unit 16. The Scorotron charger 29, the developing roller 31, and the transfer roller 30 are provided around the photosensitive drum 27.

The photosensitive drum 27 is arranged so as to contact the developing roller 31. The photosensitive drum 27 is rotatable clockwise in FIG. 1. The photosensitive drum 27 includes a conductive base and a positively charging organic photosensitive body coated on the conductive base. The positively charging organic photosensitive body is made from a charge transfer layer dispersed with a charge generation material. When the photosensitive drum 27 is exposed to a laser beam from the scanner unit 16, the charge generation material absorbs the light and generates a charge. The charge is transferred onto the surface of the photosensitive drum 27 and the conductive base through the charge transfer layer and counteracts the surface potential charged by the scorotron charger 29. As a result, a potential difference is generated between regions of the photosensitive drum 27 that have been exposed to laser beam and regions that have not been exposed to the laser beam. By selectively exposing and scanning the surface of the photosensitive drum 27 with a laser beam based upon print data, an electrostatic latent image is formed on the photosensitive drum 27.

The Scorotron charger 29 is disposed above the photosensitive drum 27. The Scorotron charger 29 is separated from and out of contact from the photosensitive drum 27 by a predetermined distance. The Scorotron charger 29 generates a corona discharge from a wire made from tungsten, for example. The Scorotron charger 29 is electrically charged with a charging bias, and electrically charges the surface of the photosensitive drum 27 to a uniform charge of positive polarity.

The developing roller 31 is disposed downstream of the scorotron charger 29 with respect to the rotation direction of the photosensitive drum 27, and is rotatable in the counterclockwise in FIG. 1. The developing roller 31 includes a roller shaft made from metal and a roller covered over the roller shaft. The roller is made from a conductive rubber material. During printing, a development bias is applied to the developing roller 31 to perform development on the photosensitive drum 27.

The toner supply roller 33 is rotatably disposed beside the developing roller 31 on the opposite side from the photosensitive drum 27 across the developing roller 31. The toner supply roller 33 is in pressed contact with the developing roller 31. The toner supply roller 33 includes a roller shaft made of metal and a roller disposed over the roller shaft. The roller is made of a conductive foam material and is adapted to triboelectrify the toner to be supplied to the developing roller 31. The toner supply roller 33 is rotatable counterclockwise in FIG. 1. This is the same rotation direction as developing roller 31.

The toner hopper 34 is provided beside the toner supply roller 33. The inside of the toner hopper 34 is filled with developer to be supplied to the developing roller 31 by way of the toner supply roller 33. In this embodiment, non-magnetic, single-component toner with a positive charging nature is used as a developer. The toner is a polymeric toner obtained by copolymerizing polymeric monomers using a well-known polymerization method such as suspension polymerization. Examples of polymeric monomers include styrene monomers and acrylic monomers. Styrene is an example of a styrene monomer. Examples of acrylic monomers include acrylic acid, alkyl (C1to C4) acrylate, and alkyl (C1 to C4) methacrylate. A coloring agent, such as carbon black, and wax are mixed in the polymeric toner. An external additive such as silica is also added in order to improve fluidity. Particle diameter of the external additive is approximately 6 to 10 μm.

A transfer roller 30 is disposed below the photosensitive drum 27 and downstream from the developing roller 31 with respect to the rotating direction of the photosensitive drum 27. The transfer roller 30 is rotatable counterclockwise in FIG. 1. The transfer roller 30 includes a metal roller shaft coated with a roller made from an ion-conductive rubber material. During the transfer process, a transfer bias is applied to the transfer roller 30. The transfer bias generates a potential difference between the surfaces of the photosensitive drum 27 and the transfer roller 30. The potential difference electrically attracts toner that has been electrostatically clinging to the surface of the photosensitive drum 27 toward the surface of the transfer roller 30.

The fixing device 18 is provided beside and downstream from the process portion 17 along the sheet conveying path indicated by a two-dot-chain line in FIG. 1. The fixing device 18 includes a fixing roller 41, and a pressure roller 42 for pressing the fixing roller 41. The fixing roller 41 is formed by coating a hollow aluminum tube with a fluorocarbon resin and sintering the assembly. The fixing roller 41 includes a halogen lamp 41a (not shown) for heating inside the metal tube. The pressure roller 42 includes a silicone rubber shaft having low hardness, and a tubular member covering the rubber shaft and formed of a fluorine resin. The silicone rubber shaft is urged upward by a spring (not shown), pressing the pressure roller 42 against the fixing roller 41. While the sheet 3 from the process portion 17 passes between the fixing roller 41 and the pressure roller 42, the fixing roller 41 pressurizes and heats a toner image that has been transferred onto the sheet 3 in the process portion 17, thereby fixing the toner onto the sheet 3. Afterward, the sheet 3 is discharged from the fixing device 18, and is transported along a semicircular-arc-shaped conveying path, before being discharged onto a discharge tray 46, which is provided on the upper surface of the case 2.

The description now turns to the configuration of the laser control device 100 provided in the scanner unit 16, with reference to FIG. 2.

As shown in FIG. 2, the laser control device 100 controls the driving of the semiconductor laser element 102a so that a laser beam is emitted from the semiconductor laser element 102a. The laser control device 100 of this embodiment uses an LD package 102 including the semiconductor laser element 102a and a photodiode 102b which are sealed into the same package. The photodiode 102b is for receiving the laser beam emitted from the semiconductor laser element 102a and for detecting the intensity thereof. The laser beam emitting section 19 is configured from the LD package 102 and a variable resistor 103. The variable resistor 103 is for generating a voltage indicative of the intensity of the laser beam detected by the photodiode 102b. Characteristics of the individual LD packages 102 differ depending on factors such as manufacturing sites and model numbers of the LD packages 102. For example, the individual LD packages 102 have differences in the intensity of the laser beam that is emitted from the semiconductor laser element 102a relative to the magnitude of currents applied thereto. The individual LD packages 102 have differences also in the magnitudes of detection currents generated from the photodiode 102b relative to the intensity of the laser beam. The variable resistor 103 enables adjustment of the different characteristics of the individual LD packages 102.

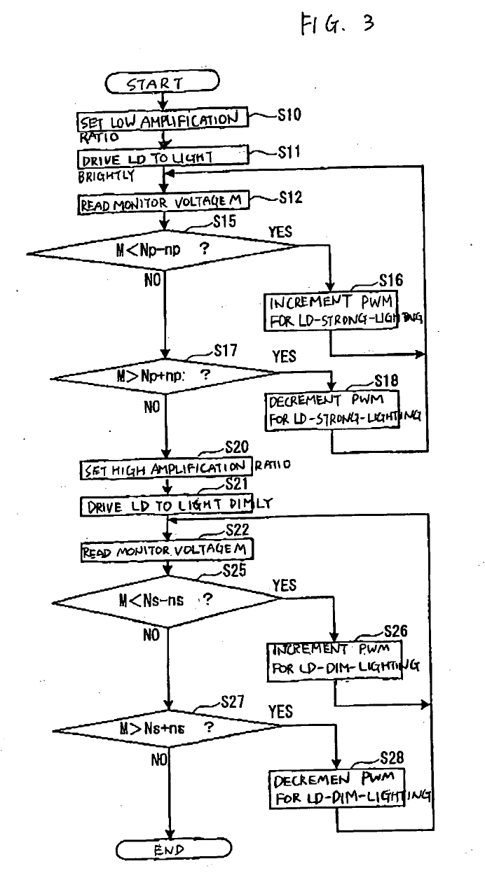

As described previously, the laser control device 100 is provided on the side surface of the casing of the scanner unit 16 (see FIG. 1), with the laser beam emitting section 19 being fixedly secured in the interior of the casing of the scanner unit 16 at a position that the laser beam emitting section 19 emits a laser beam towards the polygonal mirror 20. The laser control device 100 includes a CPU 110. The CPU 110 is for executing control of the laser control device 100. The CPU 110 is connected to a ROM 111 and a RAM 112. A predetermined storage area of the ROM 111 is prestored with: a laser control program (FIG. 3); and initial values Np, np, Ns, and ns (to be described later) that are referred to by the laser control program in order to execute adjustment in correspondence with the characteristics of the individual LD packages 102 which differ by manufacturer and model number. The RAM 112 is used for temporarily storing data during the execution of the laser control program. For example, counter values and PWM (Pulse Width Modulation) values (to be described later) used by the laser control program are temporarily stored in a predetermined storage area of the RAM 112.

The CPU 110 is connected to PWM signal conversion circuits 120 and 130. Control of the current applied to the semiconductor laser element 102a is implemented by PWM control methods. A PWM signal for making the semiconductor laser element 102a light brightly or strongly (LD-bright-lighting PWM signal) is input to the PWM signal modulation circuit 120, and a signal for making the semiconductor laser element 102a light dimly or weakly (LD-dim-lighting PWM signal) is sent to the PWM signal modulation circuit 130. The CPU 110 is installed with a PWM timer (not shown in the figure), and generates each PWM signal as a digital signal by turning on and off the PWM timer on the basis of a corresponding duty ratio. Each of the PWM signal conversion circuits 120 and 130 is a digital-to-analog converter that receives the corresponding PWM signal from the CPU 110, and converts the digital signal into an analog signal indicative of the magnitude of the currents to be applied to the semiconductor laser element 102a.

An LD-bright-lighting current drive control circuit 125 is connected to the PWM signal conversion circuit 120, and an LD-dim-lighting current drive control circuit 135 is connected to the PWM signal conversion circuit 130. Analog signals outputted from the PWM signal conversion circuit 120 are input to the corresponding LD-bright-lighting current drive control circuit 125. Analog signals outputted from the PWM signal conversion circuit 130 are input to the corresponding LD-dim-lighting current drive control circuit 135. Each of the LD-bright-lighting current drive control circuit 125 and the LD-dim-lighting current drive control circuit 135 generates currents for driving the semiconductor laser element 102a based on the received signals.

An LD drive current switching circuit 140 is connected to both of the LD-bright-lighting current drive control circuit 125 and the LD-dim-lighting current drive control circuit 135. The CPU 110 generates, on the basis of print data, a DATA signal for setting the state of the semiconductor laser element 102a to either a bright lighting state or a dim lighting state, and outputs the DATA signal to the LD drive current switching circuit 140. The LD drive current switching circuit 140 switches one of the inputs of the LD-bright-lighting current drive control circuit 125 and the LD-dim-lighting current drive control circuit 135, based on the DATA signal, and outputs the selected input to the anode of the semiconductor laser element 102a.

A cathode of the semiconductor laser element 102a is grounded and is also connected to the cathode of the photodiode 102b that is disposed nearby the semiconductor laser element 102a. The anode of the photodiode 102b is connected to: an amplification ratio adjustment circuit 150: and one end of the variable resistor 103, whose other end is grounded.

The CPU 110 outputs an amplification ratio specification signal to the amplification ratio adjustment circuit 150.

When the semiconductor laser element 102a lights brightly, a strong laser beam is received by the photodiode 102b and the voltage of an output signal from the photodiode 102b is high. Contrarily, when semiconductor laser element 102a lights dimly, the output signal from the photodiode 102b is a low-voltage output signal. For that reason, the amplification ratio adjustment circuit 150 sets the amplification ratio in correspondence with the voltage of each signal based on the amplification ratio specification signal.

In this example, when the semiconductor laser element 102a lights brightly, the amplification ratio is set to a value (low amplification ratio) that falls within a range from about 1 to about 10. When the semiconductor laser element 102a is dimmed, the amplification ratio is set to another value (high amplification ratio) that falls within another range from about 100 to about 400. The high amplification ratio for the dim lighting is therefore higher than the low amplification ratio for the bright lighting. Such a range is provided for each amplification ratio because of differences in characteristics of the individual LD packages 102 described above. Experiments or the like are previously executed by using an LD package 102 whose model number and manufacturing sites are the same as those of the LD package 102 that is actually installed in the laser control device 100, and the amplification ratio for each of the bright-lighting state and the dim-lighting state for the actually-installed LD package 102 is set to a value within the corresponding range based on the experimental results.

A monitor voltage amplifier circuit 160 is connected to the amplification ratio adjustment circuit 150. When the semiconductor laser element 102a is driven to light in either the bright or dim state, the monitor voltage amplifier circuit 160 amplifies the voltage of the output signal from the photodiode 102b at the corresponding amplification ratio that is set as described above according to the amplification ratio specification signal. The amplified voltage is input as a monitor voltage signal to the CPU 110.

The description now turns to details of the operation of the laser printer 1, with reference to FIGS. 1 and 2.

As shown in FIG. 1, when the laser printer 1 receives a print instruction from a host computer (not shown in the figure) which is operated by a user, the laser printer 1 starts feeding a paper 3 so that the paper 3 is picked up by the frictional force between the paper 3 and the rotating paper supply roller 8 and is fed to the resist rollers 12. The resist rollers 12 hold the paper 3 until they release the paper 3 at the timing at which the leading edge of a visible image formed on the surface of the rotating photosensitive drum 27 aligns with the leading edge of the paper 3.

Print data that has been generated based on the print instruction is input to the CPU 110 of the laser control device 100 in the scanner unit 16 as shown in FIG. 2. The CPU 110 generates, based on this print data, the DATA signal for switching the semiconductor laser element 102a between the bright and dim states, and outputs the DATA signal to the LD drive current switching circuit 140. In addition, the LD-bright-lighting PWM signals and the LD-dim-lighting PWM signals are output from the CPU 110. On the basis of the LD-bright-lighting PWM signals, the PWM signal conversion circuit 120 and the LD-bright-lighting current drive control circuit 125 generate drive currents for making the semiconductor laser element 102a light brightly. On the basis of the LD-dim-lighting PWM signals, the PWM signal conversion circuit 130 and the LD-dim-lighting current drive control circuit 135 generate drive currents for making the semiconductor laser element 102a light dimly. The LD drive current switching circuit 140 switches between the drive currents from the circuits 125 and 135 on the basis of the DATA signal, and applies the selected drive currents to the semiconductor laser element 102a.

The laser beam emitting section 19 having the semiconductor laser element 102a, to which the drive currents are applied, emits the laser beam toward the polygonal mirror 20 as shown in FIG. 1. The polygonal mirror 20 scans the laser beam that is incident thereto in a main scanning direction (in the direction perpendicular to the direction in which the paper 3 is fed), to emit the laser beam towards the fθ lens 20. The fθ lens 21 converts the laser beam that is scanned at a uniform angular velocity by the polygonal mirror 20 into a scan of a uniform linear velocity. The laser beam is focused by the cylinder lens 22 to form an image on the surface of the photosensitive drum 27 via the reflective mirror 23.

The charger 29 is applied with a charging bias, and electrically charges the photosensitive drum 27 so that the surface potential of the photosensitive drum 27 becomes approximately 1,000 volts. The photosensitive drum 27, which is rotating clockwise as seen in the figure, then receives the illumination of the laser beam. The laser beam, which is emitted from the semiconductor laser element 102a and which lights brightly under the control of the CPU 110, is irradiated onto portions to be developed in the main scanning direction of the paper 3. The surface potential of the photosensitive drum 27 in portions that have been illuminated by the brightly-lighting laser beam (light portions) drops to approximately 200 V. On the other hand, the laser beam, which is emitted from the semiconductor laser element 102a and which lights dimly under the control of the CPU 110, is irradiated onto portions that are not to be developed. The illumination by the dim laser beam is done at an optical intensity that has almost no effect on the surface potential of the light-sensitive drum 27 (hereinafter called “weak illumination”). As the photosensitive drum 27 rotates, the laser beam is illuminated on the photosensitive drum 27 in an auxiliary scanning direction (the direction in which the paper 3 is fed) so that an invisible electrical image (in other words, a latent image) is formed on the surface of the photosensitive drum 27 from weakly illuminated portions (dark portions) and strongly illuminated portions (light portions).

In this case, toner which has been supplied from the toner hopper 34 and which has been given a positive charge by friction between the supply roller 33 and the developer roller 31 is adjusted to be a thin film of a uniform thickness that is supported on the developer roller 31. A positive developing bias of approximately 400 V is applied to the developer roller 31. The toner which is carried on the developer roller 31 and which has been given a positive charge is transferred to the latent image formed on the surface of the photosensitive drum 27 when the rotation of the developer roller 31 brings the toner into contact with the photosensitive drum 27. In other words, since the potential of the developer roller 31 is lower than the potential of the dark portions (+1000 V) but higher than that of the light portions (+200 V), the toner transfers selectively to the low-potential light portions. Thus a visible image is formed on the surface of the light-sensitive drum 27 as an image developed by the toner.

While the paper 3 passes between the photosensitive drum 27 and the transfer roller 30, a transfer bias, which is a negative constant current of approximately −1,000 V that is even lower than the potential of the light portions (+200 V), is applied to the transfer roller 30. The visible image that has been formed on the surface of the light-sensitive drum 27 is transferred to the paper 3.

The paper 3 onto which the toner has been transferred is sent on to the fixing unit 18. The fixing unit 18 applies heat at approximately 200° C. by using the fixing roller 41 and pressure by using the pressure roller 42 to the paper 3 carrying the toner, to cause the toner on the paper 3 to melt and form a permanent image. Note that each of the fixing roller 41 and the pressure roller 42 is grounded by a diode, and the surface potential of the pressure roller 42 is lower than that of the fixing roller 41. The positively charged toner on the fixing roller 41 side of the paper 3 is attracted electrically by the pressure roller 42 through the paper 3. It is possible to prevent disruption of the image by pulling on the toner by the fixing roller 41 during the fixing.

The paper 3 onto which the toner has been fixed by heat and pressure is fed along the paper delivery path and is output into the paper delivery tray 46 with the printed surface downward. The next sheet of paper 3 printed is stacked with the printed surface downward on top of the previously output sheet in the paper delivery tray 46, in a similar manner. This enables the user to obtain sheets of paper 3 which are stacked in the print sequence.

It is possible to attain fast printing in the laser printer 1 by switching the illumination of the laser beam onto the photosensitive drum 27 rapidly between strong and weak illumination during the printing. The semiconductor laser element 102a is made to light dimly during the weak illumination of the laser beam. A drive current is continuously applied to the semiconductor laser element 102a regardless of whether the laser beam is illuminating strongly or weakly. Accordingly, the output of the laser beam emitted from the semiconductor laser element 102a will possibly gradually lose stability due to the effects of self-generated heat. If the output of the laser beam becomes unstable, variations will occur in the potentials of the light portions and the dark portions of the light-sensitive drum 27 during printing, which will lead to variations in toner density during development because electrostatic adhesion will occur in the light portions during development whereas electrostatic adhesion will not occur in the dark portions, and thus the quality of the formed image will deteriorate.

To prevent the above-described problem, according to the present embodiment, before printing starts, the laser control device 100 of the laser printer 1 executes a control operation to make constant the optical intensity of the laser beam when the semiconductor laser element 102a lights brightly and also when the semiconductor laser element 102a lights dimly. When the CPU 110 receives print data, the CPU 110 executes this control operation by executing the laser control program (FIG. 3) that is stored in the ROM 111.

The description now turns to the processing for stabilizing the laser beam with reference to FIG. 2 and in accordance with the flowchart of FIG. 3.

Before starting formation of an image based on a print instruction received from the host computer (not shown in the figure), the laser printer 1 executes the laser control program as shown in FIG. 3.

When this laser control program is started being executed, the CPU 110 applies the amplification ratio adjustment circuit 150 with an amplification ratio specification signal to set the low amplification ratio (a value in the range of approximately 1 to 10).

The LD 102a is then driven to light brightly (S11). More specifically, the CPU 110 outputs the DATA signal to the LD drive current switching circuit 140 so that the LD drive current switching circuit 140 outputs, to the semiconductor laser element 102a, the drive current for making the semiconductor laser element 102a light brightly from the LD-bright-lighting current drive circuit 125. As a result, a laser beam with a strong optical intensity is emitted from the semiconductor laser element 102a. The laser beam falls incident on the photodiode 102b, and the optical intensity thereof is detected as a voltage that is input to the amplification ratio adjustment circuit 150. The output signal from the photodiode 102b is then input to the monitor voltage amplifier circuit 160 together with the amplification ratio, that has been set in S10. The monitor voltage amplifier circuit 160 amplifies the output signal by the amplification ratio, converts the resultant amplified voltage into a digital signal (a monitor voltage signal), and outputs the monitor voltage signal to the CPU 110.

It is noted that the monitor voltage signal expresses the amount of the voltage as a count value. For example, if the monitor voltage amplifier circuit 160 has a resolution to divide a voltage of 5 volts into 512 parts, the monitor voltage amplifier circuit 160 converts an analog voltage of 2 volts, for example, into a digital value (count value) of 205. The monitor voltage amplifier circuit 160 outputs the monitor voltage signal indicative of this count value to the CPU 110.

The CPU 110 reads or inputs a monitor voltage M by temporarily storing the input count value (monitor voltage signal) in the predetermined storage area of the RAM 112 (S12).

The processing then checks whether or not the monitor voltage M is within an error range np for a reference voltage Np for the bright lighting of the semiconductor laser element 102a, by referring to the initial settings Np and np that are stored in the ROM 111. The reference voltage Np is a voltage that is obtained previously by executing experiments or the like by using an LD package 102 whose manufacturing site and the model number are the same as those of the LD package 102 that is actually installed in the laser control device 100. The reference voltage Np is previously determined to such a value that if the monitor voltage M matches this reference voltage Np, bright portions, formed on the surface of the photosensitive drum 27 by exposure from the brightly-lighting semiconductor laser element 102a, will have the desired potential (+200 V in this embodiment). The error np is determined previously by experimentation or the like, in a similar manner to the reference voltage Np, and has such a value as to ensure a permissible value from consideration of factors such as design variations and adjustment errors. If the reference voltage Np is set to 2 volts with respect to the maximum voltage of 5 volts and if an error of ±3% is permitted, the count for the error np would be ±6 with respect to the count 205 for the reference voltage Np. The determination processing of S15 and S17 checks whether or not the count for the monitor voltage M is within the range of 199 to 211.

More specifically, in S15, the processing checks whether or not the monitor voltage M is smaller than the reference voltage Np minus the error np. The count for the monitor voltage M and the count obtained by subtracting the count for the error np from the count for the reference voltage Np are compared. If the count for the monitor voltage M is found to be smaller than the count for “Np−np” (YES at S15), the PWM value for determining the duty ratio for generating the LD-bright-lighting PWM signal is incremented in S16. In other words, the PWM value is incremented by 1. This increases the duty ratio of the LD-bright-lighting PWM signal that the CPU 110 outputs to the PWM signal modulation circuit 120. The LD-bright-lighting current drive control circuit 125 increases the currents applied to the semiconductor laser element 102a based on the thus duty-ratio-increased PWM signal. As a result, the output of the laser beam from the semiconductor laser element 102a, in other words, the optical intensity thereof, is increased. The flow then returns to S12 and the optical intensity of the laser beam is again detected by the photodiode 102b in the same manner as described above.

On the other hand, if the count of the monitor voltage M is greater than or equal to the reference voltage Np minus the error np (NO at S15), the flow proceeds to S17.

In S17, the processing determines whether or not the monitor voltage M is greater than the reference voltage Np plus the error np. The count for the monitor voltage M and the count obtained by adding the count for the error np to the count for the reference voltage Np are compared. If the count for the monitor voltage M is found to be greater than the count for “Np+np” (YES at S17), the PWM value is decremented (S18). In other words, the PWM value is decremented by 1, which decreases the duty ratio of the LD-bright-lighting PWM signal that the CPU 110 outputs to the PWM signal modulation circuit 120. This weakens the optical intensity of the laser beam that is output from the semiconductor laser element 102a.

Note that the incrementation or decrementation of the count of the PWM value need not necessarily be by 1; this incrementation or decrementation could be done by any integer value in each round of processing. Alternatively, the count for the incrementation or decrementation of the PWM value could be determined depending on the magnitude of the separation of the monitor voltage M from the reference voltage Np. In such a case, the operation could be based on a table, which stores the correspondence between a plurality of magnitudes of separation and a plurality of count values and which is obtained beforehand by experimentation or the like. The flow then returns to S12 and the optical intensity of the laser beam is again detected by the photodiode 102b in the same manner as described above.

On the other hand, if the count of the monitor voltage M is less than or equal to the reference voltage Np plus the error np (NO in S17), the flow proceeds to S20.

Through the above-described processing, the count for the monitor voltage M, indicative of the optical intensity of the laser beam while the LD 102a lights brightly, is feed-back adjusted to fall within the error range np of the count of the reference voltage Np.

Next, processings of S20 to S28 are executed to provide feedback control for when the LD lights dimly, in a similar manner to the processing of S10 to S18 for when the LD lights brightly. More specifically, in S20, the CPU 110 applies the amplification ratio adjustment circuit 150 with the amplification ratio specification signal to set the high amplification ratio (a value in the range of approximately 100 to 400). The CPU 110 outputs in S21 a DATA signal to the LD drive current switching circuit 140 so that the LD drive current switching circuit 140 outputs the drive current generated by the LD-dim-lighting current drive control circuit 135 to the semiconductor laser element 102a.

The optical intensity of the laser beam is then detected by the photodiode 102b. The resultant voltage outputted from the photodiode 102b is amplified by the presently-set high amplification ratio by the monitor voltage amplifier circuit 160, and the result is converted into a digital signal (monitor voltage signal M) and input to the CPU 110. The CPU 110 reads in S22 the monitor voltage M by temporarily storing the count (monitor voltage signal) in the RAM 112 in the same manner as in S12. The CPU 110 then checks whether or not the count of the monitor voltage M is within an error range ns with respect to a reference voltage Ns by referring to the initial settings Ns and ns stored in the ROM 111. In other words, the CPU 110 checks whether or not the monitor voltage M is smaller than a value obtained by subtracting the error ns from the reference voltage Ns (S25), in a manner similar to that described for S15. If the value M is greater than or equal to the value “Ns−ns” (NO at S25), the CPU 110 checks whether or not the monitor voltage M is greater than the value obtained by adding the error ns to the reference voltage Ns (S27).

The reference voltage Ns is a voltage value obtained previously by executing experimentation or the like by using an LD package 102 whose manufacturing site and the model number are the same as those of the LD package 102 that is actually installed in the laser control device 100, in a similar manner to the reference voltage Np described above.

The reference voltage Ns has such a value that ensures that if the monitor voltage M matches the reference voltage Ns, the dimly-lighting laser beam illuminates the surface of the photosensitive drum 27 sufficiently weakly during exposure so as not to adversely affect the surface potential thereof, that is, so as to reduce the surface potential of the photosensitive drum 27 (which is originally charged to approximately 1,000 V) by an amount of zero or by a small amount that the resultant potential is still higher than the potential of the developer roller 31 (which is charged to approximately 400 V). It is most preferable that the reference voltage Ns has such a value that if the monitor voltage M matches the reference voltage Ns, the dimly-lighting laser beam illuminates the surface of the photosensitive drum 27 sufficiently weakly so as not to reduce the surface potential of the photosensitive drum 27 at all. The error ns is determined by experimentation in a similar manner to the error np, and is such a value as to ensure a permissible value from consideration of factors such as design variations and adjustment errors.

In S25, if the count for the monitor voltage M is less than the value obtained by subtracting the count for the error ns from the count for the reference voltage Ns 10 (YES at S25), the PWM value for LD dim lighting is incremented in S26 in the same manner as in S16, and, after the optical intensity of the laser beam is increased, the flow returns to S22 and the optical intensity of the laser beam is detected again. Similarly in S27, if the count for is the monitor voltage M is greater than the count obtained by adding the count for the error ns to the count for the reference voltage Ns (YES at S27), the PWM value for LD dim lighting is decremented (S28), and the flow returns to S22 after the optical intensity of the laser beam is weakened.

If the count for the monitor voltage M is less than or equal to the value obtained by adding the error ns to the reference voltage Ns (NO at S27), the laser control program ends.

In this manner, feedback control for adjusting the monitor voltage M to fall within the error range ns for the reference voltage Ns based on the optical intensity of the laser beam is performed, even when the LD lights dimly, through the processing of S20 to S28. As described above, the execution of this laser control program before printing starts ensures that even if the heat generated by the semiconductor laser element 102a itself affects the output thereof, the heat will not affect the quality of the image created.

As described above, the laser control device 100 drives the semiconductor laser element 102a to light dimly during weak illumination, to ensure rapid switching between bright-illumination and weak-illumination. For that reason, the effects of self-generated heat will possibly affect the stability of the output of the laser beam, create variations in the potentials of the light and dark portions of the light-sensitive drum 27 during printing, so that the quality of the formed image will deteriorate. However, since the laser control device 100 detects the optical intensity of the laser beam and increases or decreases the current applied to the semiconductor laser element 102a by imposing feedback control based on the thus-detected optical intensity, the laser control device 100 ensures that the optical intensity of the laser beam for each of bright-illumination and weak-illumination is kept constant.

The feedback control is performed before the formation of an image is executed based on a print instruction issued from the host computer (not shown in the figures). The feedback control is executed for both the bright irradiation and the weak irradiation. More specifically, when the semiconductor laser element 102a lights brightly, the output voltage indicative of the optical intensity of the laser beam is amplified at a low amplification ratio. Stabilization of the output of the laser beam is ensured by comparing the thus-amplified voltage with the reference value Np and by adjusting the currents applied to the semiconductor laser element 102a to ensure that the amplified voltage substantially matches the reference voltage Np. Similarly, when the semiconductor laser element 102a lights dimly, the output voltage indicative of the optical intensity of the laser beam is amplified at a high amplification ratio that is higher than the low amplification ratio used for when the semiconductor laser element 102a lights brightly. Stabilization of the output of the laser beam is ensured by comparing the amplified voltage with the reference value Ns and by adjusting the currents applied to the semiconductor laser element 102a to ensure that the amplified voltage substantially matches the reference voltage Ns.

Since the output of the laser beam while the semiconductor laser element 102a is dimmed is small, the voltage value detected by the photodiode 102b is fairly small. However, since the laser control device 100 amplifies this voltage with a relatively large amplification ratio, even tiny changes in the optical intensity, which is obtained while the semiconductor laser element 102a lights dimly, can be determined clearly by the amplification, enabling accurate feedback control.

In addition, since the control for changing the currents applied to the semiconductor laser element 102a is executed by known PWM control techniques, the control of the laser control device 100 can be executed by the CPU 110. The above-described feedback control can be attained by executing the laser control program. Even when LD packages 102, whose individual characteristics vary with manufacturing sites and model numbers, are used, feedback control that matches the individual characteristics can be performed by simply setting the initial values Np, np, Ns, ns, by simply setting the low amplification ratio in the range of about 1-10, by simply setting the high amplification ratio in the range of about 100-400 in correspondence with the LD package 102 that is actually installed in the laser control device 100.

The laser control device 100 ensures that the output of the laser beam onto the light-sensitive drum 27 is kept constant during bright illumination and that the output of the laser beam onto the light-sensitive drum 27 is kept constant during weak-illumination, thus enhancing the quality of the image that is formed.

As described above, the amplification ratio used for amplifying detection signals obtained when the semiconductor laser element 102a lights dimly is greater than that used for amplifying detection signals obtained when the semiconductor laser element 102a lights brightly. It is possible to amplify the amounts of changes in the light intensity of the weak-lighting LD 102a to sufficiently large values, thus enabling accurate feedback control. More specifically, it is possible to detect small changes in the optical intensity as large changes in the amplified detection signal level. It is therefore easy to accurately adjust the current to be applied to the laser element for dim-lighting operation.

The laser control device 100 uses the single photodiode 102b as the optical intensity detection device for detecting the optical intensity of the laser beam from the laser emission element 102a, thus enabling the use of readily-available LD package 102, thus reducing manufacturing costs.

Because the optical intensities of the laser beams for the bright and weak illuminations are adjusted by referring to the reference values Np and Ns stored in the ROM 111, it is possible to keep constant the optical intensities of the laser beams for both the strong and weak illuminations.

By using PWM control to control the optical intensities of the laser beams, it is possible to execute a digital control operation and to easily cope with changes in the components used in the laser control device 100.

The drive current for strong illumination is generated by a combination of the circuits 120 and 125, and the drive current for weak illumination is generated by a combination of the circuits 130 and 135. The combination of the circuits 130 and 135 is independent from the combination of the circuits 120 and 125. The LD drive current switching circuit 140 switches between the drive currents from the circuit 125 and the drive currents from the circuit 135. It is therefore possible to switch the strong illumination and the weak illumination rapidly.

It is possible to form an image quickly by switching rapidly between the strong illumination and the weak illumination. It is possible to keep constant the strengths of the strong illumination and the weak illumination, enabling a high level of stability in the quality of the image formed thereby.

By adjusting the strength of the weak illumination of the laser beam to substantially match the reference value Ns, it is ensured that the strength of the weak illumination has no effect on the surface color on the recording medium on which the image is formed, and therefore that there is no adverse effect on the quality of the image even when the formation of the image is speeded up.

While the invention has been described in detail with reference to the specific embodiment thereof, it would be apparent to those skilled in the art that various changes and modifications may be made therein without departing from the spirit of the invention.

For example, the laser control program may be executed every time when the laser printer 1 is turned on, every time after the laser printer 1 has printed a predetermined number of sheets, every time after a predetermined time has elapsed since the laser printer 1 has started up, or at other timings.

In the above description, the laser control device 100 is mounted in the scanner unit 16 of the laser printer 1, but the present invention is not limited thereto. The laser control device 100 can be used as a light source for: a copy machine such as a digital copier, an optical disk recording device such as a CD-R drive, an optical communications device such as an optical router, or the like.

In addition, a CPU (not shown in the figures) that controls the entire laser printer 1 may be used to serve as the CPU 110, ROM 111, and RAM 112 in the laser control device 100. In this case, the CPU 110, ROM 111, and RAM 112 may be omitted from the laser control device 100.

The amplification ratio adjustment circuit 150 and the monitor voltage amplifier circuit 160 can be provided in a single circuit.

The PWM signals can be generated by and outputted from the CPU 110 or other devices.

During the determination processing of S15, S17, S25, and S27, the laser control program performs comparisons while considering errors np and ns with respect to the reference voltages Np and Ns. However, the monitor voltage M can be adjusted so that the monitor voltage M will match the reference voltages Np and Ns directly, without consideration of errors np or ns.

What is claimed is:

1. A laser control device comprising:
a laser beam emission portion that emits a laser beam,
a laser beam drive portion that receives a modulation signal from outside and that drives the laser beam emission portion to selectively generate a laser beam of a first optical intensity and a second optical intensity that is weaker than the first optical intensity;
an optical intensity detection portion that detects the optical intensity of the laser beam emitted from the laser beam emission portion;
an amplification portion that amplifies, at an amplification ratio, a detection signal outputted from the optical intensity detection portion;
an amplification ratio setting portion that sets the amplification ratio in such a manner that the amplification ratio with respect to the detection signal for the second optical intensity is greater than the amplification ratio with respect to the detection signal for the first optical intensity; and
a control portion that outputs a control signal to the laser beam drive portion to control the laser beam drive portion to drive the laser beam emission portion to selectively emit the laser beam of the first optical intensity and the second optical intensity, the control portion including an optical intensity adjustment portion that adjusts the first optical intensity and the second optical intensity to keep constant, the optical intensity adjustment portion executing the adjustment operation based on the amplified detection signal.

2. The laser control device as claimed in claim 1, wherein the optical intensity detection portion includes a photodiode.

3. The laser control device as claimed in claim 1, further comprising a storage portion prestored with a first reference signal and a second reference signal for the first intensity and the second intensity, respectively, and
wherein the optical intensity adjustment portion includes:
a comparison portion that compares the intensity of the amplified detection signal for each of the first optical intensity and the second optical intensity with the intensity of a corresponding one of the first reference signal and the second reference signal;
a signal intensity increasing portion that increases the value of the control signal for controlling the laser beam drive portion to drive the laser beam emission portion to emit a selected one of the first optical intensity and the second optical intensity when the intensity of the amplified detection signal for the selected one of the first optical intensity and the second optical intensity is smaller than the intensity of the corresponding one of the first reference signal and the second reference signal; and
a signal intensity decreasing portion that decreases the value of the control signal for controlling the laser beam drive portion to drive the laser beam emission portion to emit a selected one of the first optical intensity and the second optical intensity when the intensity of the amplified detection signal for the selected one of the first optical intensity and the second optical intensity is greater than the intensity of the corresponding one of the first reference signal and the second reference signal.

4. The laser control device as claimed in claim 3,
wherein the control portion outputs a PWM signal as the control signal to the laser beam drive portion,
wherein the laser beam drive portion includes a signal conversion portion that converts the input PWM signal into a drive current for driving the laser beam emission portion, and
wherein the optical intensity adjustment portion adjusts each of the first optical intensity and the second optical intensity by changing an amount of the drive current applied by the signal conversion portion to the laser beam emission portion by changing a duty ratio of the PWM signal using at least one of the signal intensity increasing portion and the signal intensity decreasing portion.

5. The laser control device as claimed in claim 4,
wherein the control portion outputs a PWM signal for the first optical intensity and a PWM signal for the second optical intensity as the control signal to the laser beam drive portion,
wherein the signal conversion portion includes:
a first optical intensity signal conversion portion that receives the PWM signal for the first optical intensity and that converts the received PWM signal into a drive current for driving the laser beam emission portion to emit the laser beam of the first optical intensity;
a second optical intensity signal conversion portion that receives the PWM signal for the second optical intensity and that converts the received PWM signal into a drive current for driving the laser beam emission portion to emit the laser beam of the second optical intensity; and
a switching portion that receives the modulation signal and that switches, based on the modulation signal, application of the drive current to the laser emission portion from the first optical intensity signal conversion portion and from the second optical intensity signal conversion portion.

6. The laser control device as claimed in claim 1, further comprising an image forming portion that uses a developer to develop an electrostatic latent image formed on an image bearing body by the laser beam emitted from the laser beam emission portion, and that transfers the developed image to a recording medium, thereby forming an image.

7. The laser control device as claimed in claim 6, wherein the laser beam of the first optical intensity is for creating image-forming portions on the image bearing body, and the laser beam of the second optical intensity is for creating non-image forming portions on the image bearing body, and
wherein the optical intensity adjustment portion executes the adjustment to cause the laser beam of the second optical intensity to fail to affect color of portions on a surface of the recording medium that correspond to the non-image forming portions.

8. A laser control device comprising:
a laser diode that emits a laser beam;
a laser drive portion that drives the laser diode to selectively generate a laser beam of a first optical intensity and a second optical intensity that is weaker than the first optical intensity;
a photodiode that detects the optical intensity of the laser beam;
an amplification portion that amplifies, at an amplification ratio, a detection signal outputted from the photodiode;
an amplification ratio setting portion that sets the amplification ratio in such a manner that the amplification ratio with respect to the detection signal for the second optical intensity is greater than the amplification ratio with respect to the detection signal for the first optical intensity; and
a control portion that controls the laser drive portion to drive the laser diode to selectively emit the laser beam of the first optical intensity and the second optical intensity, the control portion including an optical intensity adjustment portion that adjusts the first optical intensity to have a predetermined first value and that adjusts the second optical intensity to have a predetermined second value, the optical intensity adjustment portion executing the adjustment operation based on the amplified detection signal.
